(19) United States
(12) Patent Application Publication
(10) Pub. No.: US 2004/0001076 A1
(43) Pub. Date: Jan. 1, 2004

(54) Method and apparatus for adjusting brightness of an LCD display

(76) Inventors: Chung-Ming Leng, Chung Li City (TW); Yu-Ping Ling, Ping Chen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/224,647

(22) Filed: Aug. 21, 2002

(30) Foreign Application Priority Data
Jul. 1, 2002 (TW) 091114500

(51) Int. Cl. G09G 5/10; G09G 3/36

(52) U.S. Cl. 345/690; 345/691; 345/102

(57) ABSTRACT

A method for adjusting the brightness of an LCD display has the steps of: (a) dividing an adjustable brightness range of the LCD display into three stages, a high brightness stage, a normal brightness stage and a low brightness stage, (b) determining which stage of said three stages has corresponded to a brightness adjust command, (c) adjusting luminance intensity of an LCD panel or luminance intensity of a lamp based on the brightness adjust command. An apparatus for performing the method has a microprocessor to receive the brightness adjust command, a PWM unit coupled to the microprocessor to adjust the current intensity of the lamp, and a voltage level controller coupled to the microprocessor to adjust the voltage level applied on the LCD panel.

### BACKGROUND OF THE INVENTION

1. Field of Invention

The present invention relates to a method and an apparatus for adjusting the brightness of an LCD display, and more particularly to a method that simultaneously controls the luminance of a lamp source and the luminance of an LCD panel so as to provide the LCD display with features of high brightness, high contrast and superior color tracking.

2. Related Art

Conventionally, brightness control means for an LCD display directs either the adjustment of the output luminance of a lamp source, or the luminance of an LCD panel, wherein the lamp source adjustment means mainly comprises two modes, a linear mode and a burst mode.

1. Linear mode: In an LCD display device, a lamp disposed behind an LCD panel is employed as the light source of the LCD display. By controlling the output luminance of the lamp, the brightness of the LCD display can be directly adjusted, wherein the output luminance of the lamp is in direct proportion to the density of the current flowing through the lamp. The advantage of such an adjusting means is that the control of the current density is a linear adjustment, and the brightness of the LCD display is only determined by the light source so that the LCD display has superior color tracking performance.

However, this kind of adjustment means still has the drawback of low brightness ratio, which is approximately 2:1, where the brightness ratio is defined by a ratio of the brightest luminance to the darkest luminance that the LCD panel can display. When a higher brightness ratio is required, the current flowing through the lamp must be accordingly reduced. However, such a small current is difficult to maintain the lamp at normal operation, so that the LCD display may possibly have flash phenomenon or the lamp can not be activated.

2. Burst mode: This adjusting means utilizes the pulse width modulator (PWM) technology to control the current flowing through the lamp so as to determine the brightness. The advantage of the PWM control is the brightness ratio can be raised to 10:1, and even higher to 15:1. However, since the switching frequency of the PWM is approximately in the range of the audio frequency (about 150 hertz to 300 hertz), the display device easily receives interference and generates audio noises. Although the PWM control can raise the brightness ratio to 10:1, the brightness ratio 5:1 for the ordinary users is just enough. Further, such a PWM control means involves high cost and thus the competitiveness of such products in the market is accordingly reduced.

In another aspect, the luminance of the lamp remains at a constant and the brightness of the LCD display is adjusted by the luminance of the LCD panel, i.e. the gain of the LCD panel. For example, if the gain of an LCD panel is 100%, 60% of the gain is provided to the brightness adjustment, and the remaining 40% gain is provided to the contrast adjustment. Obviously, the contrast performance of the LCD display is sacrificed.

To overcome the shortcomings, a brightness adjusting method and apparatus for an LCD display in accordance with the present invention obviates or mitigates the aforementioned drawbacks.

### SUMMARY OF THE INVENTION

The primary objective of the present invention is to provide a method and an apparatus for adjusting brightness of an LCD display, wherein the brightness adjusting method simultaneously controls the gain of an LCD panel and the luminance of a lamp to ensure the LCD display has superior contrast and color tracking performance.

To achieve the objective, the method for adjusting brightness of an LCD display that has a light source and an LCD panel, the method comprises the steps of:

dividing an adjustable brightness range of the LCD display into three stages, a high brightness stage, a normal brightness stage and a low brightness stage;

determining which stage of said three stages has been corresponded to bya brightness adjust command;

wherein, if said brightness adjust command corresponds to the bright section, the luminance of the light source of the LCD display is adjusted; if said brightness adjust command corresponds to the dark section, the luminance of the LCD panel is adjusted; if said brightness adjust command corresponds to the normal section, the luminance of the light source and the LCD panel are simultaneously adjusted.

The apparatus for adjusting the brightness of the LCD display in accordance with the present invention comprises:

a microprocessor for receiving a brightness adjust command;

a PWM control unit coupled to and controlled by the microprocessor to determine the intensity of a current flowing through the light source of the LCD display;

a voltage level controller coupled to the microprocessor to output a voltage signal to an LCD panel so as to adjust the luminance of the LCD panel.

Other objectives, advantages and novel features of the invention will become more apparent from the following detailed description when taken in conjunction with the accompanying drawings.

### BRIEF DESCRIPTION OF THE DRAWINGS

FIG. 1 is block diagram of an apparatus for adjusting brightness of an LCD display in accordance with the present invention;

FIG. 2 is a graph showing the relationship of the luminance (Y-axis) versus the brightness adjust value (X-axis) of the LCD display in accordance with the present invention; and

FIG. 3 is a flow chart showing the adjusting method in accordance with the present invention.

### DETAILED DESCRIPTION OF THE INVENTION

The brightness of an LCD display is determined by two factors, one is the luminance of an LCD panel, and the other one is the luminance of a lamp, which is the light source of the LCD display, disposed behind the LCD panel. Thus, the present invention intends to provide a method and an apparatus that selectively or simultaneously control said two factors to adjust the brightness based on an adjust command.

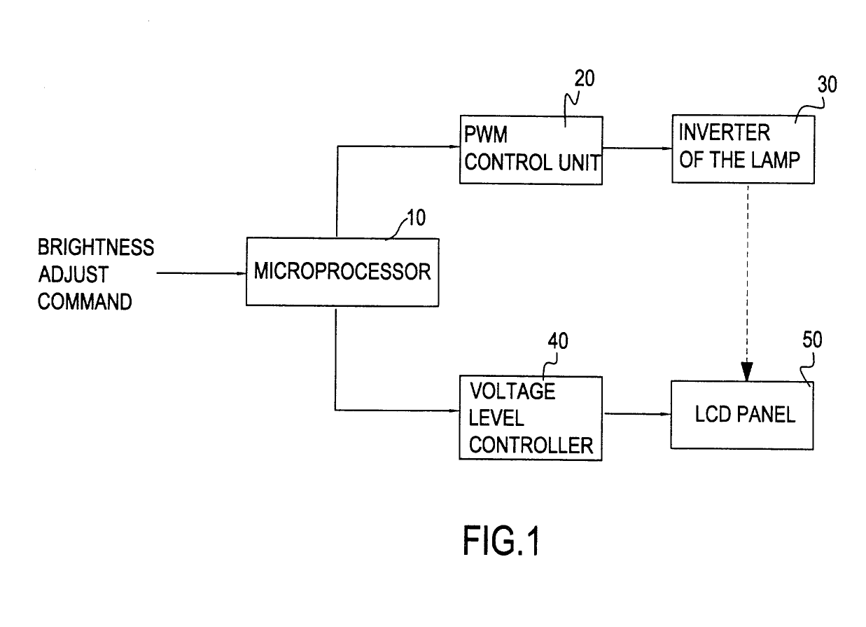

With reference to FIG. 1, an apparatus for adjusting the brightness of an LCD display in accordance with the present invention includes a microprocessor (10), a pulse width modulator (PWM) control unit (20) coupled to an output terminal of the microprocessor (10), an inverter (30) of a lamp controlled by the PWM control unit (20), a voltage controller (40) coupled to an output of the microprocessor (10), and an LCD panel (50).

When the microprocessor (10) receives an adjust command, the microprocessor (10) will determine whether the brightness control process is performed by the PWM unit (20), the voltage level controller (40), or achieved by both, based on the adjust command.

By controlling the pulse width of the output signals of the PWM unit (20) based on the adjust command, the intensity of the current that flows through the inverter (30) is accordingly varied, so that the output luminance of the lamp is changed. In another aspect, when the brightness adjust command is performed by the voltage level controller (40), the luminance of the LCD panel (50) is in direct proportion to the voltage level of the output signal of the voltage level controller (40).

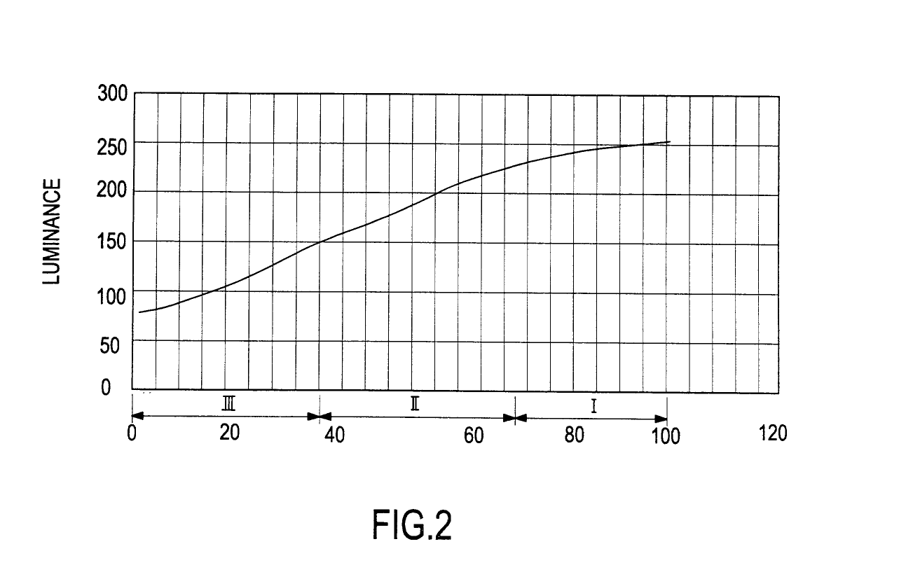

With reference to FIG. 2, the graph shows a character curve that represents the relationship between the luminance of the LCD display (Y-axis) and the adjust values of the brightness control command (X-axis). For example, when a user presses adjust buttons of the LCD display, an on-screen-display (OSD) menu, which contains many adjustable items to be selected, is immediately displayed on the screen. In the “brightness” item, the adjustable brightness range is generally divided into a 0-100 scale to represent different brightnesses achievable. When the user presses the control button to chose a desired value, the selected value is deemed as the adjust command.

The method in accordance with the present invention firstly defines the adjustable range 0-100 as three stages. In this embodiment, the range 100-50 is deemed as a high brightness stage (I), the range 49-35 is deemed as a normal brightness stage (II), and the range 34-00 is deemed as a low brightness stage (III).

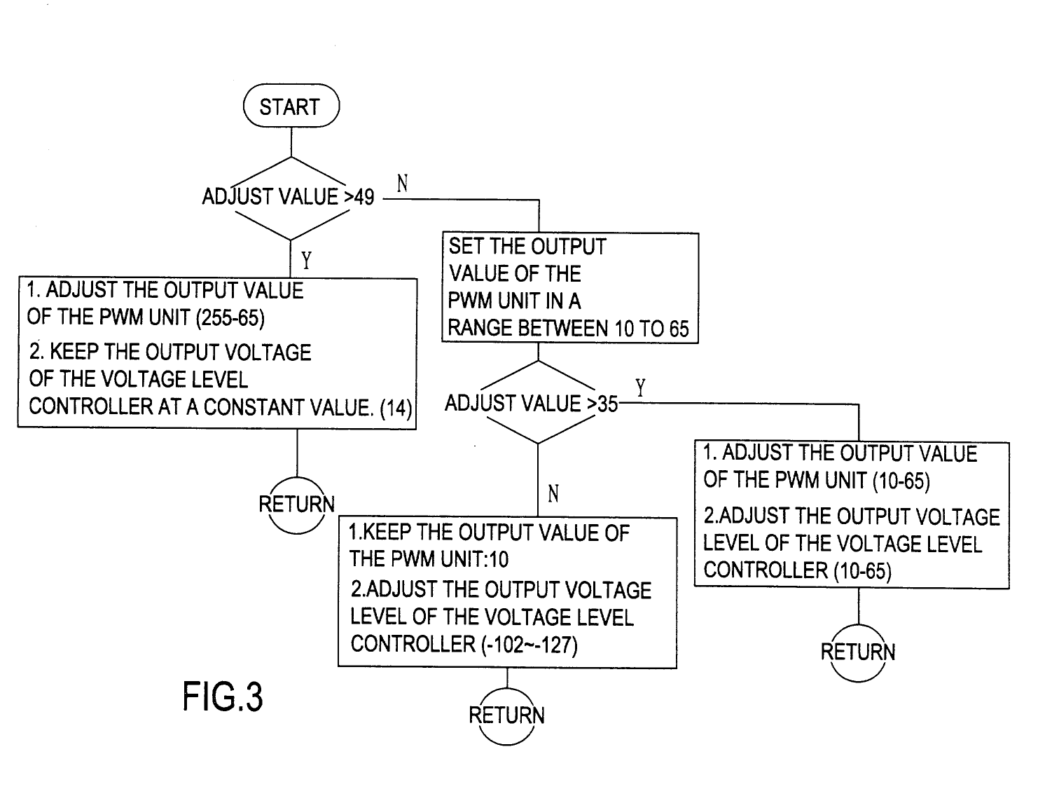

Thereafter, with reference to FIGS. 1 and 3, the brightness adjust command input to the microprocessor sent by the user through the OSD menu is determined to be in which stage. Firstly, when the adjust value of the command is greater than 49, i.e. the adjust command is in the high brightness stage, the microprocessor (10) only controls the PWM unit (20) to correspondingly adjust the pulse width of the output signals. Since the intensity of the current flowing through the inverter (30) is changed, the output luminance of the lamp is adjusted based on the current intensity. In the high brightness stage, the output voltage level of the voltage level controller (40) is kept at a constant value. In this embodiment, the resolution of the PWM unit (20) is represented with a 256 scale (0 to 255), and the resolution of the voltage controller (40) is defined as the 256 scale (+128 to −127).

If the adjust value is not greater than 49, the microprocessor (10) further determines whether the adjust value is greater than 35. If the adjust value is in the range between 35-49, i.e. the normal brightness stage, the PWM control unit (20) and the voltage level controller (40) respectively control the inverter (30) and the LCD panel (50). Otherwise, if the adjust value is lower than 35, i.e. the low brightness stage, the output of the PWM unit (20) is kept at a constant low value to reduce the output luminance of the lamp. The voltage level controller (40) independently adjusts the luminance of the LCD panel (50). Since the luminance of the lamp is reduced, the LCD device has superior brightness ratio (higher than 4:1) and some problems, such as color-aberration and color-overflow, are avoided.

The invention may be varied in many ways by a skilled person in the art. Such variations are not to be regarded as a departure from the spirit and scope of the invention, and all such modifications are intended to be included within the scope of the following claims.

What is claimed is:

1. A method for adjusting brightness of an LCD display that has an LCD panel and a lamp used as a light source of the LCD display, the method comprising the steps of:
dividing an adjustable brightness range of the LCD device into several stages;
determining a stage of a brightness adjust command; and
adjusting luminance intensity of the LCD panel or luminance intensity of the lamp based on the brightness adjust command.

2. The method as claimed in claim 1, wherein the adjustable brightness range of the LCD device is divided into a high brightness stage, a normal brightness stage and a low brightness stage; wherein when the brightness adjust command corresponds to the high brightness stage, the luminance intensity of the lamp is adjusted; wherein when the brightness adjust command corresponds to the low brightness stage, the luminance intensity of the LCD panel is adjusted; wherein when the brightness adjust command corresponds to the normal brightness stage, the luminance intensity of the lamp and the LCD panel are adjusted collectively.

3. The method as claimed in claim 2, wherein the lamp is adjusted through a pulse width modulation (PWM) means.

4. The method as claimed in claim 2, wherein the luminance intensity adjustment of the LCD panel is determined by a voltage level that applies to the LCD panel.

5. The method as claimed in claim 3, wherein the luminance intensity adjustment of the LCD panel is determined by a voltage level that applies to the LCD panel.

6. An apparatus for adjusting brightness of an LCD display that has an LCD panel and a lamp used as a light source of the LCD display, the apparatus comprises:
a microprocessor to receive a brightness adjust command;
a PWM control unit coupled to and controlled by the microprocessor to determine an intensity of a current flowing through the lamp of the LCD display; and
a voltage level controller coupled between an output terminal of the microprocessor and the LCD panel to output a voltage signal to the LCD panel so as to adjust the luminance of the LCD panel;
wherein, based on an adjust value of the brightness adjust command, the microprocessor determines whether brightness of the LCD display is controlled by the lamp via the PWM control unit, or by the LCD panel via the voltage level controller, or collectively controlled by the lamp and the LCD panel.

7. The apparatus as claimed in claim 6, wherein an adjustable brightness range of the LCD device is divided into a high brightness stage, a normal brightness stage and a low brightness stage; wherein when the brightness adjust command corresponds to the high brightness stage, the luminance intensity of the lamp is adjusted; wherein when the brightness adjust command corresponds to the low brightness stage, the luminance intensity of the LCD panel is adjusted; wherein when the brightness adjust command corresponds to the normal brightness stage, the luminance intensity of the lamp and the LCD panel are adjusted collectively.
